(19) United States
(12) Patent Application Publication
(10) Pub. No.: US 2026/0300706 A1
(43) Pub. Date: Oct. 1, 2026

(54) COHERENCE POTENTIAL ASSAY FOR BRAIN STATE AND COGNITIVE CHANGE DETECTION

(71) Applicants: Tara Thiagarajan, Arlington, VA (US); Narayan Subramaniyam, Espoo (FI); Dhanya Parameshwaran, Chennai (IN)

(72) Inventors: Tara Thiagarajan, Arlington, VA (US); Narayan Subramaniyam, Espoo (FI); Dhanya Parameshwaran, Chennai (IN)

(21) Appl. No.: 19/578,862

(22) Filed: Mar. 25, 2026

Related U.S. Application Data
(60) Provisional application No. 63/777,639, filed on Mar. 25, 2025.

(51) Int. Cl. G06N 3/06

(52) U.S. Cl. CPC G06N 3/061

(57) ABSTRACT

Methods, systems, and devices for coherence potential assay for brain state and cognitive change detection are described. In some implementations, a data processing device may receive brain signal data from sensors connected to a subject and may detect events corresponding to deflections exceeding a predetermined amplitude threshold. The device may form a correlation matrix based on waveform similarity between the detected events and may cluster the events into groups using the correlation matrix. Connectivity metrics, including mean inter-event intervals, maximum inter-event intervals, and spatial characteristics derived from sensor positions, may be computed for the clusters. The device may compare the computed connectivity metrics to stored population benchmark values to determine brain states or cognitive changes. The determined brain states or cognitive changes may then be outputted by the data processing device.

### CROSS REFERENCE TO RELATED APPLICATIONS

The present application for patent claims priority to U.S. Provisional Patent Application No. 63/777,639, filed on Mar. 25, 2025, entitled COHERENCE POTENTIAL ASSAY, which is hereby incorporated by reference in its entirety.

### FIELD OF TECHNOLOGY

The present disclosure relates generally to database systems and data processing, and more specifically to systems and methods for performing coherence potential assays for brain state and cognitive change detection.

### BACKGROUND

Functional connectivity analysis involves studying statistical interdependencies between brain regions to understand their interaction during cognitive and behavioral functions. Brain signals may be measured using techniques such as electroencephalography, electrocorticography, microelectrode arrays, and magnetoencephalography.

### SUMMARY

The described techniques relate to improved methods, systems, devices, and apparatuses that support techniques for coherence potential assays for brain state and cognitive change detection. Some implementations may provide systems and methods for detecting coherence potentials in brain signals, clustering these events based on waveform similarity, and deriving novel connectivity metrics to assess brain states or cognitive changes. Coherence potentials may be defined as clusters of high-amplitude, highly correlated waveforms that propagate across the brain without distortion. By identifying these clusters and analyzing their size distributions, inter-event intervals, and spatial characteristics, some implementations may enable a detailed understanding of the spatial and temporal dynamics of brain activity. These metrics may then be compared to population benchmarks stored in a constantly updated database to determine deviations or changes in brain states.

Some implementations may utilize advanced signal processing techniques to extract coherence potentials from brain signals obtained through electroencephalography, electrocorticography, microelectrode arrays, or magnetoencephalography. Clustering may be performed using hierarchical algorithms based on waveform correlation, and connectivity measures may be derived to quantify the relationships between electrodes or sensors. Statistical analyses may be applied to assess differences in connectivity metrics across tasks or conditions, providing a robust framework for identifying cognitive changes. Some implementations may further incorporate artificial intelligence techniques, such as machine learning, to enhance the accuracy and reliability of brain state assessments, offering significant improvements over traditional connectivity analysis methods.

A method for coherence potential assay for brain state and cognitive change detection is described. The method may include receiving, by a data processing device, brain signal data from sensors connected to a subject. The method may include detecting, by the data processing device, events in the brain signal data, wherein the events may correspond to deflections exceeding a predetermined amplitude threshold. The method may include forming, by the data processing device, a correlation matrix based on waveform similarity between the detected events. The method may include clustering, by the data processing device, the detected events into groups based on the correlation matrix. The method may include computing, by the data processing device, connectivity metrics for the clusters, wherein the connectivity metrics may include mean inter-event intervals, maximum inter-event intervals, and spatial characteristics derived from sensor positions. The method may include comparing, by the data processing device, the computed connectivity metrics to stored population benchmark values to determine brain states or cognitive changes. The method may include outputting, by the data processing device, the brain states or cognitive changes.

A system configured for coherence potential assay for brain state and cognitive change detection is described. The system may include a processor and memory coupled with the processor. The system may include instructions stored in the memory and executable by the processor to cause the system to receive brain signal data from sensors connected to a subject. The system may detect events in the brain signal data, wherein the events may correspond to deflections exceeding a predetermined amplitude threshold. The system may form a correlation matrix based on waveform similarity between the detected events. The system may cluster the detected events into groups based on the correlation matrix. The system may compute connectivity metrics for the clusters, wherein the connectivity metrics may include mean inter-event intervals, maximum inter-event intervals, and spatial characteristics derived from sensor positions. The system may compare the computed connectivity metrics to stored population benchmark values to determine brain states or cognitive changes. The system may output the brain states or cognitive changes.

Another system for coherence potential assay for brain state and cognitive change detection is described. The system may include means for receiving brain signal data from sensors connected to a subject. The system may include means for detecting events in the brain signal data, wherein the events may correspond to deflections exceeding a predetermined amplitude threshold. The system may include means for forming a correlation matrix based on waveform similarity between the detected events. The system may include means for clustering the detected events into groups based on the correlation matrix. The system may include means for computing connectivity metrics for the clusters, wherein the connectivity metrics may include mean inter-event intervals, maximum inter-event intervals, and spatial characteristics derived from sensor positions. The system may include means for comparing the computed connectivity metrics to stored population benchmark values to determine brain states or cognitive changes. The system may include means for outputting the brain states or cognitive changes.

A non-transitory computer-readable medium storing code for coherence potential assay for brain state and cognitive change detection is described. The code may include instructions executable by a processor to receive brain signal data from sensors connected to a subject. The code may include instructions executable by a processor to detect events in the brain signal data, wherein the events may correspond to deflections exceeding a predetermined amplitude threshold. The code may include instructions executable by a processor to form a correlation matrix based on waveform similarity between the detected events. The code may include instructions executable by a processor to cluster the detected events into groups based on the correlation matrix. The code may include instructions executable by a processor to compute connectivity metrics for the clusters, wherein the connectivity metrics may include mean inter-event intervals, maximum inter-event intervals, and spatial characteristics derived from sensor positions. The code may include instructions executable by a processor to compare the computed connectivity metrics to stored population benchmark values to determine brain states or cognitive changes. The code may include instructions executable by a processor to output the brain states or cognitive changes.

Some examples of the method, systems, and non-transitory computer-readable medium described herein may further include operations, features, means, or instructions for detecting events in the brain signal data in response to deflections falling below a predetermined amplitude threshold. The operations, features, means, or instructions may further include forming a correlation matrix based on waveform similarity between the detected events.

Some examples of the method, systems, and non-transitory computer-readable medium described herein may further include operations, features, means, or instructions for determining connectivity metrics for the clusters. The connectivity metrics may include connection frequency and inter-event intervals derived from temporal characteristics of the detected events.

Some examples of the method, systems, and non-transitory computer-readable medium described herein may further include operations, features, means, or instructions for comparing the computed connectivity metrics to stored individual baseline values in addition to the population benchmark values to determine brain states or cognitive changes.

Some examples of the method, systems, and non-transitory computer-readable medium described herein may further include operations, features, means, or instructions for receiving brain signal data from sensors configured to detect electrical activity, magnetic activity, or derivatives of electrical activity in the brain.

Some examples of the method, systems, and non-transitory computer-readable medium described herein may further include operations, features, means, or instructions for outputting brain states or cognitive changes as visualizations. The visualizations may include spatial network plots with edge thickness representing connection frequency and edge color representing inter-event intervals.

In some examples of the method, systems, and non-transitory computer-readable medium described herein, the brain signal data may be pre-processed to filter noise and artifacts prior to detecting events.

In some examples of the method, systems, and non-transitory computer-readable medium described herein, the correlation matrix may be formed based on waveform similarity across multiple sensors simultaneously.

In some examples of the method, systems, and non-transitory computer-readable medium described herein, the amplitude threshold for detecting events may be dynamically adjusted in response to variations in baseline activity.

In some examples of the method, systems, and non-transitory computer-readable medium described herein, the connectivity metrics computed may include spatial trajectories of clusters derived from sensor positions.

In some examples of the method, systems, and non-transitory computer-readable medium described herein, the population benchmark values may be updated in response to newly acquired brain signal data from additional subjects.

In some examples of the method, systems, and non-transitory computer-readable medium described herein, the brain states or cognitive changes may be output as statistical summaries in addition to visualizations.

### BRIEF DESCRIPTION OF THE DRAWINGS

FIG. 1 illustrates an example of a system for data processing that supports coherence potential assays for brain state and cognitive change detection in accordance with aspects of the present disclosure.

FIG. 2 shows EEG signal analysis which supports techniques for coherence potential assay for brain state and cognitive change detection in accordance with various aspects of the present disclosure.

FIG. 3 shows a block diagram of an apparatus that supports coherence potential assays for brain state and cognitive change detection in accordance with various aspects of the present disclosure.

FIG. 4 shows a block diagram of a brain signal analysis component that supports coherence potential assays for brain state and cognitive change detection in accordance with various aspects of the present disclosure.

FIG. 5 shows a diagram of a system including a device that supports coherence potential assays for brain state and cognitive change detection in accordance with various aspects of the present disclosure.

FIG. 6 shows flowchart illustrating a method that supports coherence potential assays for brain state and cognitive change detection in accordance with various aspects of the present disclosure.

FIG. 7 shows the number of clusters decreasing linearly with larger event clusters.

FIG. 8 shows statistical testing approaches to analyze group-level difference between a pair of tasks for a test example.

FIG. 9 shows a spatial visualization of the coherence potential characteristics for the test example.

FIG. 10 shows the cumulative distribution function (CDF) of pairwise CP connectivity measures for a test example.

FIG. 11 shows the CDF of other connectivity measures for group-analysis for the test example.

FIG. 12 shows a comparison of subject-level permutation test results for the proposed CP connectivity measures with spectral-based connectivity metrics (alpha-band) and mutual information for the test example.

### DETAILED DESCRIPTION

Methods, systems, devices, and apparatuses that support techniques for coherence potential assays for brain state and cognitive change detection are disclosed. In some examples, current methods for analyzing brain signals and functional connectivity may lack the ability to consistently identify and characterize brain states or cognitive changes in a clinically or application-relevant manner. Techniques such as spectral coherence, phase locking value, and mutual information may provide limited insight into the spatial and temporal dynamics of brain activity, often failing to capture the nuanced interplay between brain regions. Furthermore, these methods may not adequately address the need for robust benchmarks to compare individual brain states against population norms. This limitation may hinder the development of reliable tools for assessing mental capacity, cognitive enhancement, or deterioration, particularly in applications requiring high sensitivity and specificity.

In some implementations, systems and methods may detect clusters of brain activity referred to as coherence potentials, which may represent periods of high-amplitude signals with similar shapes. These coherence potentials may be identified by detecting deflections in brain signals that exceed a threshold, which may range from one to three times the standard deviation of the baseline signal in either the negative or positive direction. Brain signals may be obtained using various techniques, including electroencephalography, electrocorticography, microelectrode arrays, and magnetoencephalography, which may measure electrical activity or related changes in the brain. Once detected, coherence potentials may be grouped into clusters based on the similarity of their waveform shapes, which may be calculated using correlation metrics. A correlation matrix may be created to represent relationships between pairs of events, and a distance matrix may be derived by subtracting the correlation coefficient from one, enabling agglomerative hierarchical clustering to group events based on waveform similarity.

In some implementations, the clustering process may use the average linkage method to calculate distances between clusters, with thresholds for clustering potentially varying between 0.1 and 0.8. Coherence potentials may be defined as clusters formed at a threshold of 0.3, which may correspond to a level of similarity associated with critical patterns of brain activity. The characteristics of these clusters may be analyzed to derive connectivity metrics, which may include the size of the clusters, representing the number of events within each cluster. The distribution of cluster sizes may follow a power-law pattern, indicating scale-free properties, with the power-law exponent varying based on the clustering threshold. Additional metrics may include inter-event intervals, which may measure the time differences between events within clusters and may be calculated as mean, maximum, and minimum values, as well as connection frequency, which may represent the proportion of possible connections between pairs of electrodes within clusters and may be normalized to values between zero and one.

In some implementations, spatial characteristics of coherence potential clusters may be assessed based on the positions of electrodes or sensors. These spatial metrics may include the distribution of events within clusters and the trajectories of coherence potentials across the electrode array. Spatial characteristics may be visualized using network plots, where nodes may represent electrodes and edges may represent connections. The thickness of the edges may correspond to connection frequency, while the color of the edges may represent inter-event intervals. Statistical characteristics of coherence potential clusters may also be compared to population benchmarks, which may be derived from a continuously updated database of population data. Metrics may further be compared to an individual's baseline to assess changes in cognitive states over time, providing insights into brain activity dynamics.

In some implementations, coherence potential metrics may be used to analyze brain states associated with specific tasks, such as eyes closed, eyes open, pattern completion, and working memory. Each task may exhibit distinct connectivity patterns, with the eyes-closed task potentially showing global increases in connection frequency, while the working memory task may be characterized by higher connection frequencies and faster inter-event intervals across all electrode pairs. The pattern completion task may exhibit slower inter-event intervals and selective high connection frequencies. Cognitive changes, such as enhancement or deterioration, may be assessed by comparing coherence potential metrics before and after an intervention or over time. Statistical analysis may be performed to evaluate the ability of coherence potential metrics to distinguish between different tasks, with group-level analysis involving mean pairwise connectivity values across subjects and subject-level analysis comparing pairwise connectivity values within individual subjects.

In some implementations, coherence potential-based metrics may be compared to traditional connectivity measures, such as absolute coherence, imaginary coherence, phase locking value, and mutual information. Coherence potential metrics may distinguish between tasks more effectively than traditional measures, offering a more nuanced understanding of brain activity. Software may be included to analyze coherence potentials, which may identify and cluster coherence potentials within and across individuals, compute cluster parameters such as size, inter-event intervals, and spatial characteristics, and compare these metrics to stored benchmarks. This software may operate on various computing systems, including personal computers, servers, laptops, and distributed environments, and may support multiple configurations of electroencephalography devices and data acquisition methods. Artificial intelligence methods, such as neural networks, reinforcement learning, and clustering algorithms, may also be integrated to enhance the analysis of coherence potentials and connectivity metrics.

In some implementations, brain signal data may be acquired under different experimental conditions, such as eyes closed, eyes open, pattern completion, and working memory tasks. These signals may be preprocessed using filters to remove noise and prepare the data for analysis. Coherence potentials may exhibit criticality and scale-free behavior, as evidenced by power-law distributions of cluster sizes, which may align with known patterns of neuronal activity. Connectivity metrics may be represented using cumulative distribution functions to visualize differences between tasks and assess statistical significance. Spatial characteristics may also be visualized using network plots to provide insights into connectivity patterns, offering a comprehensive view of brain activity.

In some implementations, the methods may be adapted to alternative signal sources, such as magnetoencephalography, which may measure magnetic fields generated by brain activity. Statistical testing approaches may be used to analyze connectivity metrics, with group-level analysis involving comparisons of mean pairwise connectivity values across subjects and subject-level analysis assessing individual differences. Permutation testing may be used to evaluate statistical significance, and results may be corrected for multiple comparisons. These methods may be applied to clinical and research contexts, such as studying brain disorders, assessing treatment effects, and developing brain-computer interfaces. By leveraging coherence potential metrics, these implementations may provide valuable tools for understanding and analyzing complex brain activity.

Aspects of the subject matter described in this disclosure can be implemented to realize one or more of the following potential advantages. The described techniques may be implemented to support the identification of brain activity patterns that may provide insights into cognitive processes and neural dynamics. These methods may enable the detection of coherence potentials that may represent critical periods of synchronized neuronal activity, which may be relevant for understanding task-specific brain states. The clustering of coherence potentials may facilitate the derivation of connectivity metrics that may reveal spatial and temporal characteristics of brain activity, which may be useful for assessing cognitive changes or brain disorders. The described systems may operate across various signal acquisition methods, which may include electrical or magnetic measurements, to ensure compatibility with diverse experimental setups. Statistical testing approaches may be applied to evaluate the significance of connectivity metrics, which may enhance the reliability of brain state assessments in clinical or research contexts.

Aspects of the disclosure are initially described in the context of networked computing systems. Aspects of the disclosure are additionally illustrated by and described with reference to example implementations. Aspects of the disclosure are further illustrated by and described with reference to apparatus diagrams, system diagrams, and flowcharts that relate to coherence potential assay for brain state and cognitive change detection.

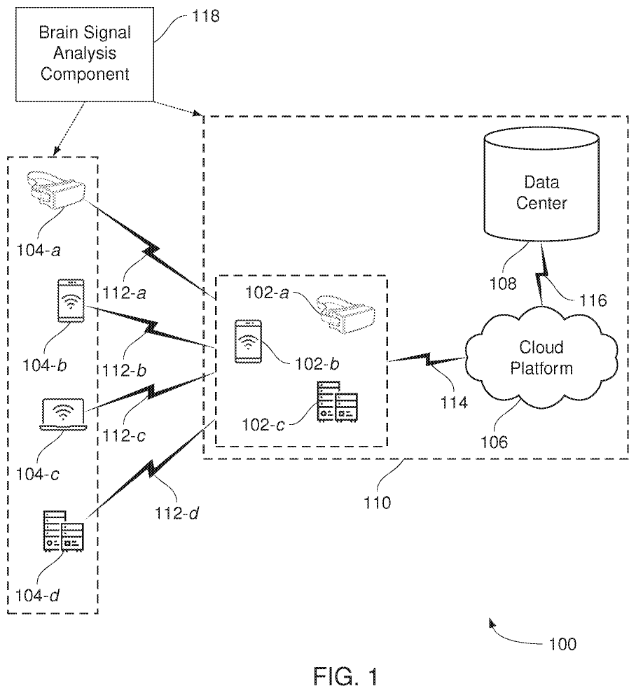

FIG. 1 illustrates an example of a system 100 that supports coherence potential assays for brain state and cognitive change detection in accordance with various aspects of the present disclosure. The system 100 includes cloud clients 102, user devices 104, a cloud platform 106, and a data center 108. Cloud platform 106 may be an example of a public or private cloud network. A cloud client 102 may access cloud platform 106 over a network connection 114. The network connection 114 may include a wired connection, a wireless connection, or both. The network may implement transfer control protocol and internet protocol (TCP/IP), such as the Internet, or may implement other network protocols. A cloud client 102 may be an example of a computing device, such as a wearable device (e.g., cloud client 102-a), a smartphone (e.g., cloud client 102-b), or a server (e.g., cloud client 102-c). In other examples, a cloud client 102 may be a desktop or laptop computer, a tablet, a sensor, or another computing device or system capable of generating, analyzing, transmitting, or receiving communications. In some examples, a cloud client 102 may be part of a business, an enterprise, a non-profit, a startup, or any other organization type.

A cloud client 102 may facilitate communication between the data center 108 and one or multiple user devices 104 to implement an online environment. The network connection 112 may include communications, opportunities, purchases, sales, or any other interaction between a cloud client 102 and a user device 104. The network connection 112 may include a wired connection, a wireless connection, or both. A cloud client 102 may access cloud platform 106 to store, manage, and process the data communicated via one or more network connections 112. In some cases, the cloud client 102 may have an associated security or permission level. A cloud client 102 may have access to certain applications, data, and database information within cloud platform 106 based on the associated security or permission level, and may not have access to others.

The user device 104 may include a brain signal analysis component 118. The user device 104 may interact with the cloud client 102 over network connection 112. The network may implement transfer control protocol and internet protocol (TCP/IP), such as the Internet, or may implement other network protocols. The network connection 112 may facilitate transport of data via email, web, text messages, mail, or any other appropriate form of electronic interaction (e.g., network connections 112-a, 112-b, 112-c, and 112-d) via a computer network. In an example, the user device 104 may be computing device such as a wearable device 104-a, a smartphone 104-b, a laptop 104-c or a server 104-d. In other cases, the user device 104 may be another computing system. In some cases, the user device 104 may be operated by a user or group of users. The user or group of users may be a customer, associated with a business, a manufacturer, or any other appropriate organization.

Cloud platform 106 may offer an on-demand database service to the cloud client 102. In some cases, cloud platform 106 may be an example of a multi-tenant database system. In this case, cloud platform 106 may serve multiple cloud clients 102 with a single instance of software. However, other types of systems may be implemented, including—but not limited to—client-server systems, mobile device systems, and mobile network systems. In some cases, cloud platform 106 may support an online application. This may include support for sales between buyers and sellers operating user devices 104, service, marketing of products posted by buyers, community interactions between buyers and sellers, analytics, such as user-interaction metrics, applications (e.g., computer vision and machine learning), and the Internet of Things (IoT). Cloud platform 106 may receive data associated with generation of an online environment from the cloud client 102 over network connection 114, and may store and analyze the data. In some cases, cloud platform 106 may receive data directly from a user device 104 and the cloud client 102. In some cases, the cloud client 102 may develop applications to run on cloud platform 106. Cloud platform 106 may be implemented using remote servers. In some cases, the remote servers may be located at one or more data centers 108.

Data center 108 may include multiple servers. The multiple servers may be used for data storage, management, and processing. Data center 108 may receive data from cloud platform 106 via connection 116, or directly from the cloud client 102 or via network connection 112 between a user device 104 and the cloud client 102. The connection 116 may include a wired connection, a wireless connection, or both. Data center 108 may utilize multiple redundancies for security purposes. In some cases, the data stored at data center 108 may be backed up by copies of the data at a different data center (not pictured).

Server system 110 may include cloud clients 102, a cloud platform 106, a brain signal analysis component 118, and a data center 108 that may coordinate with cloud platform 106 and data center 108 to implement an online environment. In some cases, data processing may occur at any of the components of server system 110, or at a combination of these components. Thus, the brain signal analysis component 118 may be included in the user device 104, server system 110, or in part or in whole in both. In some cases, servers may perform the data processing. The servers may be a cloud client 102 or located at data center 108.

Some or all of the functionality attributed to the brain signal analysis component 118 may be embodied or performed by one or more user devices 104, one or more components of server system 110 (e.g., cloud clients 102, a cloud platform 106, and/or a data center 108), and/or other components of system 100. The brain signal analysis component 118 may receive signals and inputs from user device 104 directly. via cloud clients 102, and/or via cloud platform 106 or data center 116.

As described herein, the brain signal analysis component 118 may process brain signal data received from sensors connected to a subject to detect events corresponding to deflections exceeding a predetermined amplitude threshold. The component may form a correlation matrix based on waveform similarity between the detected events and may cluster the events into groups using the correlation matrix. Connectivity metrics, such as mean inter-event intervals, maximum inter-event intervals, and spatial characteristics derived from sensor positions, may be computed for the clusters. These computed metrics may be compared to stored population benchmark values to determine brain states or cognitive changes. The results of this analysis may be output by the brain signal analysis component 118 to the user device 110, cloud client 102, or cloud platform 106 for further use or display.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

In some embodiments, the functionality of system 100 is implemented in a standalone local computer system without reliance on a remote cloud platform 106 or data center 108. In such embodiments, a local computing device, such as a desktop computer, laptop computer, tablet, workstation, or embedded processor system, may include or execute the brain signal analysis component 118 and may be directly coupled to one or more brain signal sensors positioned on the subject. The sensors may be communicatively coupled to the local computing device via wired connections (for example, USB, serial, or dedicated EEG interfaces) and/or wireless connections (for example, Bluetooth, Wi-Fi, or other short-range wireless protocols). The local computing device may receive brain signal data from the sensors, detect events corresponding to deflections exceeding a predetermined amplitude threshold, form a correlation matrix based on waveform similarity between detected events, cluster the events into groups, compute connectivity metrics for the clusters, and compare the connectivity metrics to locally stored population benchmark values to determine brain states or cognitive changes. In these embodiments, the results of the analysis may be stored locally and/or presented directly on one or more output devices associated with the local computing device (for example, a display, speaker, or printer), and communication with any remote server or cloud platform is optional or omitted altogether.

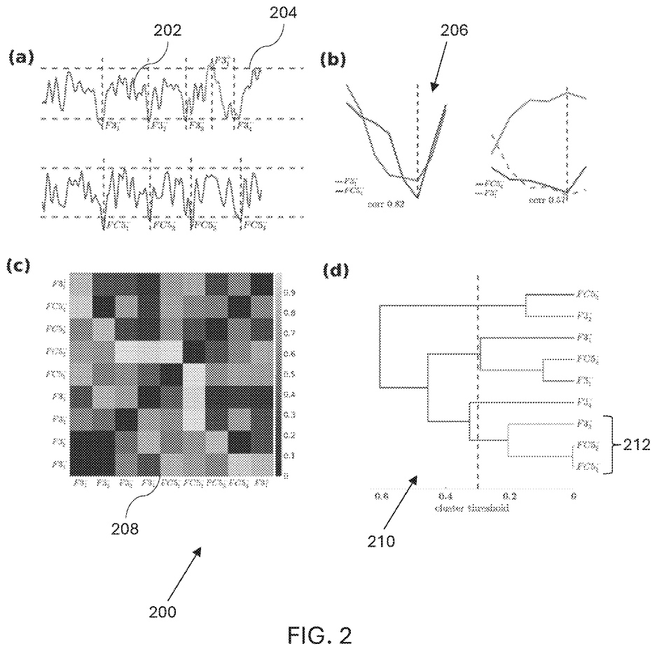

FIG. 2 shows EEG signal analysis 200 which supports techniques for coherence potential assays for brain state and cognitive change detection in accordance with various aspects of the present disclosure. As depicted in FIG. 2, the EEG signal analysis 200 may include one or more of an EEG signal 202, a threshold line 204, a detected event 206, a correlation matrix 208, a dendrogram 210, a cluster 212, and/or other components.

The EEG signal 202 may represent electrical activity detected from the brain through electrodes placed on the scalp. The EEG signal 202 may include time-series data that reflects the electrical activity of neurons in the brain. The EEG signal 202 may be recorded using various devices, such as the Emotiv EPOC system, which may include multiple channels like AF3, AF4, F3, F4, F7, F8, FC5, FC6, T7, T8, P7, P8, O1, and O2. The EEG signal 202 may be processed to remove noise and artifacts, such as filtering with a high-pass cutoff of 0.16 Hz and a low-pass cutoff of 40 Hz. In some implementations, the EEG signal 202 may be used to detect coherence potentials, which may represent clusters of highly correlated waveforms.

The threshold line 204 may indicate a predefined amplitude level used to identify significant deflections in the EEG signal. The threshold line 204 may be set based on statistical measures, such as two times the standard deviation of the baseline EEG signal averaged across all channels. The threshold line 204 may help distinguish periods of large amplitude deflections from the baseline activity. The threshold line 204 may be adjusted depending on the experimental conditions or the characteristics of the EEG signal. In some implementations, the threshold line 204 may be used to identify events that may correspond to coherence potentials.

The detected event 206 may include periods of large amplitude deflections in the EEG signal that surpass the threshold line. The detected event 206 may represent moments of significant neural activity that may be associated with specific brain states or tasks. The detected event 206 may be characterized by its peak amplitude, duration, and waveform shape. The detected event 206 may be identified across multiple EEG channels, and its characteristics may be compared to other detected events. In some implementations, the detected event 206 may be clustered based on waveform similarity to determine coherence potentials.

The correlation matrix 208 may represent the similarity between waveform shapes of detected events across multiple EEG channels. The correlation matrix 208 may be determined by aligning the peaks of detected events and comparing their waveform shapes using a correlation metric. The correlation matrix 208 may include values that range from −1 to 1, indicating the degree of similarity between events. The correlation matrix 208 may be used to group events into clusters based on their waveform similarity. In some implementations, the correlation matrix 208 may be visualized to identify patterns in the EEG signal.

The dendrogram 210 may illustrate hierarchical clustering of detected events based on their waveform correlations. The dendrogram 210 may be constructed using agglomerative hierarchical clustering methods, such as the average linkage method. The dendrogram 210 may represent the relationships between events as a tree-like structure, with branches indicating clusters of similar events. The dendrogram 210 may be used to determine the number of clusters and their composition at different distance thresholds. In some implementations, the dendrogram 210 may help identify coherence potentials by grouping events with similar waveform characteristics.

The cluster 212 may include groups of detected events that share similar waveform characteristics as determined by the dendrogram. The cluster 212 may be defined based on a distance threshold applied to the correlation matrix. The cluster 212 may represent coherence potentials, which may be characterized by their size, spatial distribution, and inter-event intervals. The cluster 212 may be analyzed to determine connectivity metrics, such as connection frequency and mean inter-event interval. In some implementations, the cluster 212 may be compared to population benchmarks to assess brain states or cognitive changes.

In some implementations, the EEG signal 202 may be processed to identify deflections that exceed the threshold line 204, which may represent a predefined amplitude threshold. Detected events 206 may correspond to these deflections and may include both positive and negative peaks. The correlation matrix 208 may be constructed to represent the similarity between the waveforms of the detected events 206, with each entry in the matrix indicating the degree of correlation between a pair of events.

In some implementations, the dendrogram 210 may be generated based on the correlation matrix 208 to group the detected events 206 into clusters 212. The clustering process may involve determining the distance between events as one minus their correlation coefficient and applying hierarchical clustering methods. The clusters 212 may represent groups of events with similar waveform shapes, and their organization may depend on the selected clustering threshold.

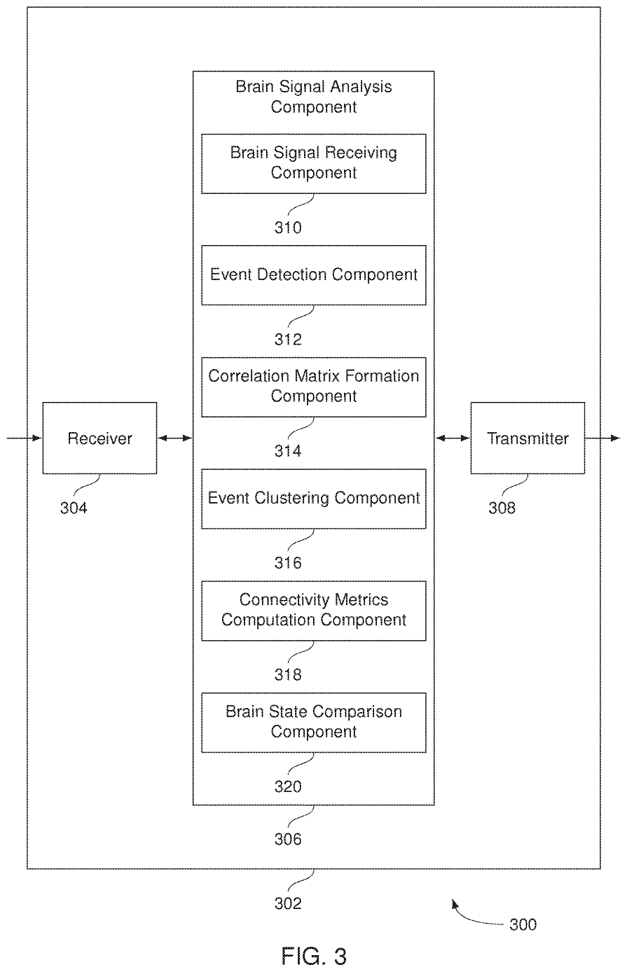

FIG. 3 shows a block diagram 300 of an apparatus 302 that supports coherence potential assay for brain state and cognitive change detection in accordance with various aspects of the present disclosure. The apparatus 302 may include an input module 304, brain signal analysis component 306, and an output module 308. The apparatus 302 may also include a processor. Each of these components may be in communication with one another (e.g., via one or more buses). In some cases, the apparatus 302 may be an example of a user terminal, a database server, or a system containing multiple computing devices.

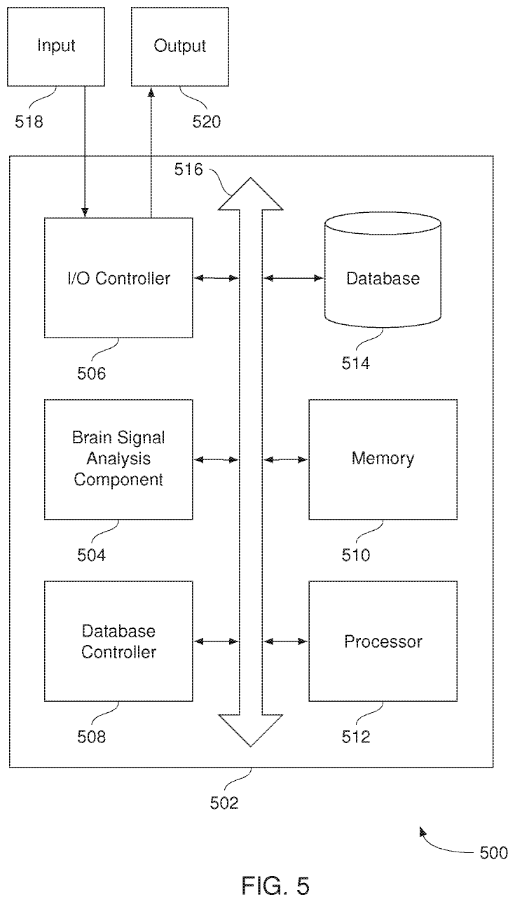

The input module 304 may manage input signals for the apparatus 302. For example, the input module 304 may identify input signals based on an interaction with a modem, a keyboard, a mouse, a touchscreen, or a similar device. These input signals may be associated with user input or processing at other components or devices. In some cases, the input module 304 may utilize an operating system such as iOS®, ANDROID®, MS-DOS®, MS-WINDOWS®, OS/2®, UNIX®, LINUX®, or another known operating system to handle input signals. The input module 304 may send aspects of these input signals to other components of the apparatus 302 for processing. In some cases, the input module 304 may be a component of an input/output (I/O) controller 506 as described with reference to FIG. 5.

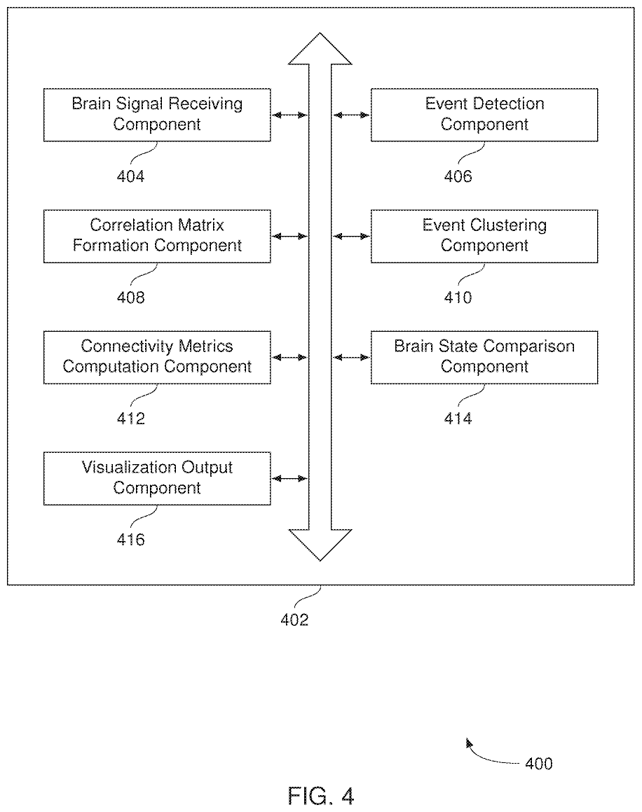

The brain signal analysis component 306 may include one or more of a brain signal receiving component 310, an event detection component 312, a correlation matrix formation component 314, an event clustering component 316, a connectivity metrics computation component 318, a brain state comparison component 320, and/or other components. The brain signal analysis component 306 may be an example of aspects of the brain signal analysis component 402 or 504 described with reference to FIGS. 4 and 5.

The brain signal receiving component 310 may be configured as or otherwise support a means for receiving brain signal data from sensors connected to a subject. The event detection component 312 may be configured as or otherwise support a means for detecting events in the brain signal data, wherein the events may correspond to deflections exceeding a predetermined amplitude threshold. The correlation matrix formation component 314 may be configured as or otherwise support a means for forming a correlation matrix based on waveform similarity between the detected events. The event clustering component 316 may be configured as or otherwise support a means for clustering the detected events into groups based on the correlation matrix. The connectivity metrics computation component 318 may be configured as or otherwise support a means for computing connectivity metrics for the clusters, wherein the connectivity metrics may include mean inter-event intervals, maximum inter-event intervals, and spatial characteristics derived from sensor positions. The brain state comparison component 320 may be configured as or otherwise support a means for comparing the computed connectivity metrics to stored population benchmark values to determine brain states or cognitive changes and outputting the brain states or cognitive changes.

The output module 308 may manage output signals for the apparatus 302. For example, the output module 308 may receive signals from other components of the apparatus 302, such as the brain signal analysis component 306, and may transmit these signals to other components or devices. In some specific examples, the output module 308 may transmit output signals for display in a user interface, for storage in a database or data store, for further processing at a server or server cluster, or for any other processes at any number of devices or systems. In some cases, the output module 308 may be a component of an I/O controller 506 as described with reference to FIG. 5.

In accordance with various embodiments, the brain signal analysis component 306 may utilize any of a variety of clustering methods for determining the brain state or cognitive change. One such method includes but is not limited to the following:

### Exemplary Methods

Exemplary methods will be described herein as applied to the use of Electrocorticographs as a detector of electrical activity generated by the brain.

### A. Data Acquisition

For the purpose of demonstration, EEG data was recorded for 3 minutes under four different experimental conditions—1) Eyes Closed (EC) 2) Eyes Open (EO) 3) Pattern Completion (PC) and 4) Working Memory (WM). For the EC condition, the participants were instructed to relax with eyes closed. For the EO condition, the participants were instructed to have their eyes open and look at images on a laptop screen. The WM task involved iteratively retracing a pattern on a grid starting with a three dot pattern which increased in difficulty until the subject failed. The PC task utilized a Raven's progressive matrix which consisted of five questions related to pattern recognition, each in order of increasing difficulty and was administered using paper and pencil.

EEG recordings were performed using the Emotiv EPOC system with channels AF3, AF4, F3, F4, F7, F8, FC5, FC6, T7, T8, P7, P8, O1 and O2. The EEG signals were high-pass-filtered with a 0.16 Hz cutoff, pre-amplified, and low-pass-filtered at an 83 Hz cutoff. The analog signals were then digitized at 2048 Hz and filtered using a 5th-order sinc notch filter (50 and 60 Hz) before being down-sampled to 128 Hz (company communication). Signals were low-pass filtered at 40 Hz for further analysis.

However various other EEG devices, electrode configurations, reference conditions and internal signal acquisition or pre-processing methods may be used.

### B. Definition of Coherence Potentials

Clusters of high amplitude potentials of highly correlated waveforms are defined as coherence potentials (CPs).

C. Identification of Coherence Potentials and their Clustering

Identification of coherence potentials and extraction of correlation matrices is shown in FIG. 2. Events are defined as periods of deflections from the baseline where the peak exceeded a threshold. This threshold is typically defined to be 2*SD, where SD is the standard deviation of the baseline EEG (for e.g. eyes closed EEG) averaged across all the channels. For each EEG electrode, both positive and negative periods of signal deflections exceeding the threshold are extracted. FIG. 2(a) shows an example of EEG data from two electrodes (F3 and FC5) with periods of positive and negative deflections that cross the threshold (+2SD). Four large amplitude negative deflections are detected on FC3 and FC5 while one large amplitude positive deflection is detected on FC3. FIG. 2(b) show the steps involved in computing the correlation between two events (positive or negative) crossing the threshold, which serves as a measure of the similarity of the waveform shape. The waveform similarity between two events is computed using a simple correlation metric after aligning the peaks of the two signals (vertical dashed lines) as shown in FIG. 2(b). Where the events are of different lengths to the left and right of the peak, the signal period equivalent to the longer event is used. FIG. 2(b) also shows a scenario where correlation is computed to estimate the similarity between a positive and a negative deflection (F31+ and FC54−). In this case, before calculating the correlation the sign of one of the waveform is flipped so that only the similarity in the waveform shape is considered, discarding the sign of deflection. Given that there are M such events (i.e., positive or negative deflections crossing 2SD) across all the electrodes, a correlation matrix can be formed. For the purpose of visualization, a 9×9 correlation matrix containing similarity between the nine signal deflections is shown in FIG. 2(c). After computing the correlation matrix R, the events are clustered using agglomerative hierarchical clustering based on a distance matrix D=I−R, where R is the correlation matrix and I the identity matrix. Thus the distance value for each entry in the matrix is expressed as one minus the correlation coefficient. We used the average linkage method to calculate the distance between the clusters as the average linkage method had the highest cophenetic correlation compared to other linkage methods. We then varied the distance threshold between 0.1 to 0.8 in steps of 0.1 to visualize behavior at different thresholds. In the example shown in FIG. 2, after obtaining the correlation matrix for 9 events (FIG. 2(c)), hierarchical clustering at a distance threshold of 0.3 results in four clusters represented by three colors (green, red, blue and black) as shown in FIG. 2(d).

### D. Cluster Size Distributions

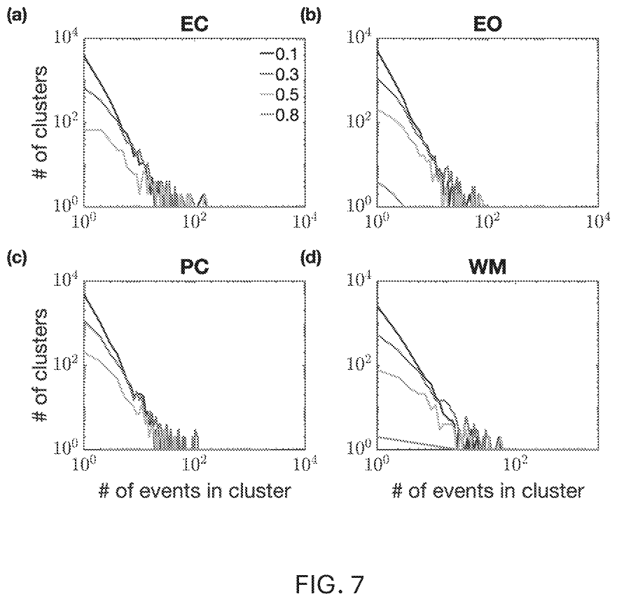

To see how clusters changed with the threshold of this distance metric first look at the relationship between the number of clusters and cluster size (i.e., number of events in a cluster) for different cluster thresholds. For all the tasks, pooled across all the subjects, the resulting cluster size distribution could be well fit by a power law distribution for cluster thresholds 0.1, 0.3 and 0.5, with the number of clusters decreasing linearly with larger event clusters (FIG. 7(a)-(d) for tasks EC, EO, PC and WM). The slope of the distribution was steeper as the cluster threshold decreased with a power-law exponent a, averaged across EC, EO, PC and WM, of −2.32±0.07, −1.49±0.09 and −1.27±0.12 for cluster thresholds 0.1, 0.3 and 0.5 respectively with goodness of fit ranging between 0.95 and 0.99). The power law distribution suggests scale free behavior and the exponent of ≈1.5 at cluster threshold 0.3 aligns with the avalanche statistics of Coherence Potentials identified in both rats and monkeys, and is associated with the concept of criticality. A 0.3 threshold was used going forward where coherence potentials are defined as clusters arising at this threshold of similarity of waveform shape. Note that for the higher clustering threshold of 0.8 (corresponding to a lower threshold of similarity), the majority of events (≈95%) were within a single cluster and thus the behaviour was not explained well by the power-law fit (the goodness of fit for power-law fit ranged between 0.4-0.6 with exponent −0.1±0.08). However a power law distribution may not arise in all behavioral paradigms and a clustering threshold may be chosen to maximize variance.

### A. Coherence Potential Based Connectivity Metrics

Define the following connectivity measures between each pair of electrodes within each event cluster of Coherence Potentials (CPs) as,
Mean inter-event interval,
Maximum inter-event interval,
Minimum inter-event interval,
Connection frequency,

The measures, and CP_{τ}_{ₘᵢₙ} are based on the event peak times. If there are N_{i,p} and N_{j,p} events on electrodes i and j in cluster p, then the inter event interval between electrodes i and j in cluster p is computed as,
where and are the peak times (in seconds) of events m and n on electrodes i and j respectively.

$${t}_{i}^{m}$$

Let be the total number of clusters and be the number of clusters clusters that contain events from electrodes i and j, i.e., P′⊂P. The mean interaction measure CP_{τ} between electrodes i and j is given as,
where is the total number of clusters and be the number of clusters clusters that contain events from electrodes i and j, i.e., P′⊂P. Similarly, for cluster p compute

$${CP}_{{τ}_{min}^{p}} and {CP}_{{τ}_{max}^{p}}$$

as,

Similar to, to compute and CP_{τ}_{ₘₐₓ} take the mean over all the P clusters which contain events from electrodes i and j,

To compute the connection frequency first define the measure between two electrodes in a cluster based on the possible number of connections as,
where and are the total number of events detected on channels i and j in cluster p. Here,

$${CP}_{{λ}_{ij}^{p}}$$

represents the possible connections between all events on electrodes i and j in cluster p. If within a given cluster p, events from electrodes i and j do not co-occur, then set

$${CP}_{{λ}_{ij}^{p}} = 0$$

If there are a total of clusters, the number of connections between electrodes and j is given by the CP metric,
where and are the total number of events detected on channels i and j. The term NᵢNⱼ in the denominator normalizes CP_{λ} to have values in the range of 0 and 1.

### Statistical Analysis

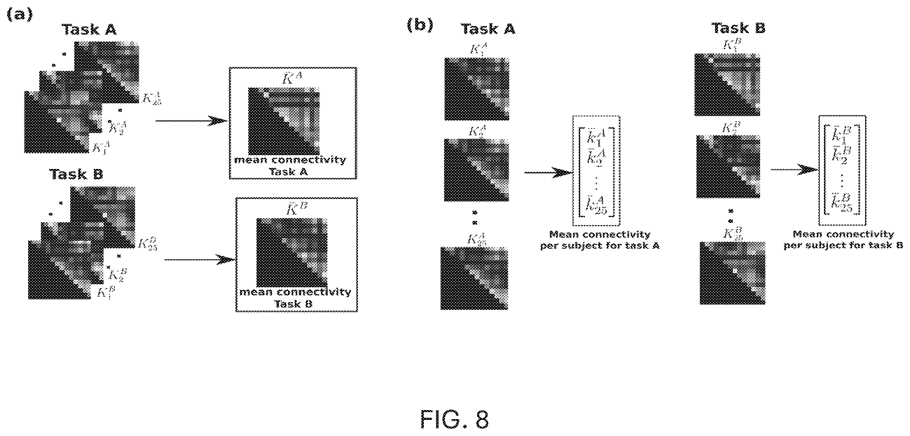

Statistical analysis is not limited to but may include one or more of the following, which can be referred to as TEST 1, TEST 2 and TEST 3 to assess the ability of the newly proposed connectivity measures based on coherence potentials to distinguish between different tasks and to compare them with other functional connectivity metrics (absCoh, imCoh, PLV and MI). We define and as the upper triangle of a symmetric connectivity matrix for subject i for tasks A and B, computed using CPs or other connectivity methods. Permutation testing may be performed using the three example approaches described below and in all cases corrections are made for multiple comparisons using the Bonferroni-Holm method. FIG. 8 shows the pipeline to conduct statistical comparison using TEST 1 and TEST 2.

Statistical testing approaches may be used to analyze group-level difference between a pair of tasks. (a) TEST 1—Mean pairwise connectivity values across 25 subjects is computed for each task (Task A box) and permutation test is used to test the difference between the two tasks. (b) TEST2—Pairwise connectivity values are averaged to obtain a single connectivity value per subject for each task (Task B box). Permutation testing is used to assess the difference between two tasks.

i. TEST 1: Group-Level Analysis

The mean of the pairwise connectivity values which, in an example case, amounts to 91 pairwise connectivity values, (considering the upper triangle of symmetric 14×14 connectivity matrix and excluding the diagonals) across each the subjects (N=25) for each task. In FIG. 8 this is denoted as and for any two tasks A and B. To test the null hypothesis that the functional connectivity matrices are not different between the two tasks, permutation testing was conducted to generate the null distribution using 5000 permutations. The difference in distance between the cumulative distribution functions (CDFs) of the pairwise connectivity values for the any two tasks was used as the test statistic in permutation testing for comparing task pairs.

ii. TEST 2: Group-Level Analysis

For this group-level analysis, the mean of pairwise connectivity values (=91) is computed for each subject and task. For any two tasks A and B, this results in two vectors and as shown in FIG. 8(b). Again, to test the null hypothesis that the functional connectivity matrices for the two tasks A and B are not different, permutations testing was conducted using 5000 permutations. The difference in means of k̅^{A} and k̅^{B} was used as the test statistic for permutation testing.

iii. TEST 3: Subject-Level Analysis

In subject-level analysis, the null hypothesis that the difference between pairwise connectivity values and for an individual subject i is not different between any two tasks A and B. In an example, permutation testing with 5000 permutations was used to test for significance in connectivity matrices between two tasks for each subject. The percentage of subjects that reject the null hypothesis is then reported.

Referring now to FIG. 4 a block diagram 400 shows a brain signal analysis component 402 that supports coherence potential assays for brain state and cognitive change detection in accordance with various aspects of the present disclosure. The brain signal analysis component 402 may be an example of aspects of a brain signal analysis component 306, a brain signal analysis component 504, or both, as described herein. The brain signal analysis component 402, or various components thereof, may be an example of means for performing various aspects of coherence potential assays for brain state and cognitive change detection as described herein. For example, the brain signal analysis component 402 may include one or more of a brain signal receiving component 404, an event detection component 406, a correlation matrix formation component 408, an event clustering component 410, a connectivity metrics computation component 412, a brain state comparison component 414, a visualization output component 416, and/or other components. Each of these components may communicate, directly or indirectly, with one another (e.g., via one or more buses).

The brain signal receiving component 404 may be configured as or otherwise support a means for receiving brain signal data from sensors connected to a subject. In some implementations, the brain signal receiving component 404 may include wireless communication capabilities to receive data from sensors via Bluetooth or other wireless protocols. The brain signal receiving component 404 may be integrated with a wired connection system to transfer brain signal data through physical cables for enhanced signal stability. The brain signal receiving component 404 may support compatibility with various sensor types, such as dry electrodes, gel-based electrodes, or microelectrode arrays. The brain signal receiving component 404 may include preprocessing capabilities to filter noise or artifacts from the received brain signal data before further analysis.

The event detection component 406 may be configured as or otherwise support a means for detecting events in the brain signal data, wherein the events may correspond to deflections exceeding a predetermined amplitude threshold. In some implementations, the event detection component 406 may determine deflections based on both positive and negative signal peaks that surpass the threshold. The event detection component 406 may include functionality to adjust the amplitude threshold dynamically based on the standard deviation of baseline brain signal activity. In some implementations, the event detection component 406 may determine events by aligning signal peaks across multiple electrodes to identify correlated deflections.

The correlation matrix formation component 408 may be configured as or otherwise support a means for forming a correlation matrix based on waveform similarity between the detected events. In some implementations, the correlation matrix formation component 408 may determine waveform similarity by aligning the peaks of detected events across multiple electrodes. In some implementations, the correlation matrix formation component 408 may determine similarity by flipping the sign of negative deflections to focus solely on waveform shape. In some implementations, the correlation matrix formation component 408 may determine a distance matrix by subtracting the correlation coefficient from an identity matrix to quantify dissimilarity between events.

The event clustering component 410 may be configured as or otherwise support a means for clustering the detected events into groups based on the correlation matrix. In some implementations, the event clustering component 410 may determine clusters by applying agglomerative hierarchical clustering methods to the correlation matrix. In some implementations, the event clustering component 410 may determine clusters by varying the distance threshold between 0.1 and 0.8 to observe clustering behavior at different levels of similarity. In some implementations, the event clustering component 410 may determine clusters by using the average linkage method to assess the distance between clusters based on waveform similarity.

The connectivity metrics computation component 412 may be configured as or otherwise support a means for computing connectivity metrics for the clusters, wherein the connectivity metrics may include mean inter-event intervals, maximum inter-event intervals, and spatial characteristics derived from sensor positions. In some implementations, the connectivity metrics computation component 412 may determine mean inter-event intervals by averaging the time differences between consecutive events within a cluster across all sensors. In some implementations, the connectivity metrics computation component 412 may determine maximum inter-event intervals by identifying the longest time difference between consecutive events within a cluster. In some implementations, the connectivity metrics computation component 412 may determine spatial characteristics by mapping the positions of sensors involved in the detected events and analyzing their spatial distribution.

The brain state comparison component 414 may be configured as or otherwise support a means for comparing the computed connectivity metrics to stored population benchmark values to determine brain states or cognitive changes. In some implementations, the brain state comparison component 414 may determine brain states by comparing connectivity metrics such as inter-event intervals and spatial characteristics to benchmark values derived from a database of EEG recordings from diverse populations. In some implementations, the brain state comparison component 414 may determine cognitive changes by analyzing deviations in connectivity metrics over time relative to baseline values stored for an individual subject. In some implementations, the brain state comparison component 414 may determine brain states by incorporating statistical testing methods, such as permutation testing, to assess the significance of differences between computed metrics and benchmark values.

The visualization output component 416 may be configured as or otherwise support a means for outputting brain states or cognitive changes. In some implementations, the visualization output component 416 may output brain states as graphical network plots where nodes represent electrodes and edges represent connectivity metrics such as inter-event intervals or connection frequencies. In some implementations, the visualization output component 416 may output cognitive changes as color-coded heatmaps that display variations in connectivity metrics across different brain regions. In some implementations, the visualization output component 416 may output brain states as cumulative distribution function plots that illustrate differences in connectivity measures across various tasks or conditions.

In some examples, the event detection component 406 may be configured as or otherwise support a means for detecting events in the brain signal data in response to deflections that may fall below a predetermined amplitude threshold and forming a correlation matrix that may be based on waveform similarity between the detected events. In some implementations, the event detection component 406 may determine deflections by analyzing both positive and negative peaks in the brain signal data that may surpass the threshold. In some implementations, the event detection component 406 may adjust the amplitude threshold dynamically based on variations in the standard deviation of baseline brain signal activity across different experimental conditions. In some implementations, the event detection component 406 may detect events by aligning signal peaks across multiple electrodes to identify correlated deflections that may occur simultaneously.

In some examples, the connectivity metrics computation component 412 may be configured as or otherwise support a means for determining connectivity metrics for the clusters, wherein the connectivity metrics may include connection frequency and inter-event intervals derived from temporal characteristics of the detected events. In some implementations, the connectivity metrics computation component 412 may determine connection frequency by analyzing the co-occurrence of events across multiple electrodes within a cluster. In some implementations, the connectivity metrics computation component 412 may determine inter-event intervals by measuring the time differences between consecutive peaks of detected events within the same cluster.

In some implementations, the connectivity metrics computation component 412 may determine connection frequency by normalizing the number of connections between events to the total possible connections within a cluster. In some implementations, the connectivity metrics computation component 412 may determine inter-event intervals by averaging the temporal differences between events across all sensor pairs involved in a cluster. In some implementations, the connectivity metrics computation component 412 may determine connection frequency by assessing the proportion of synchronized events across electrode pairs relative to the total detected events.

In some examples, the brain state comparison component 414 may be configured as or otherwise support a means for comparing the computed connectivity metrics to stored individual baseline values in addition to the population benchmark values to determine brain states or cognitive changes. In some implementations, the brain state comparison component 414 may determine brain states by analyzing deviations in connectivity metrics relative to baseline values recorded during specific experimental conditions. In some implementations, the brain state comparison component 414 may assess cognitive changes by comparing connectivity metrics across multiple time points to identify trends or fluctuations in brain activity patterns.

In some implementations, the brain state comparison component 414 may determine brain states by incorporating statistical methods such as permutation testing to evaluate the significance of differences between computed metrics and stored values. In some implementations, the brain state comparison component 414 may compare connectivity metrics to population benchmark values derived from EEG recordings segmented by demographic factors such as age or gender. In some implementations, the brain state comparison component 414 may determine cognitive changes by examining variations in spatial characteristics of clusters across different experimental tasks.

In some examples, the brain signal receiving component 404 may be configured as or otherwise support a means for receiving brain signal data from sensors that may be configured to detect electrical activity, magnetic activity, or derivatives of electrical activity in the brain. In some implementations, the brain signal receiving component 404 may include compatibility with sensors that may detect changes in magnetic fields produced by neuronal currents, such as magnetoencephalography sensors. In some implementations, the brain signal receiving component 404 may support sensors that may measure electrical activity through scalp electrodes, including dry or gel-based configurations. In some implementations, the brain signal receiving component 404 may integrate with microelectrode arrays that may detect localized electrical activity directly from cortical surfaces.

In some examples, the visualization output component 416 may be configured as or otherwise support a means for outputting brain states or cognitive changes as visualizations, wherein the visualizations may include spatial network plots with edge thickness representing connection frequency and edge color representing inter-event intervals. In some implementations, the visualization output component 416 may determine edge thickness by analyzing the proportion of synchronized events across electrode pairs relative to the total detected events. In some implementations, the visualization output component 416 may determine edge color by mapping inter-event intervals to a gradient scale, where shorter intervals may correspond to warmer colors and longer intervals may correspond to cooler colors.

In some implementations, the visualization output component 416 may output spatial network plots with nodes representing electrode positions and edges representing connectivity metrics derived from coherence potential clusters. In some implementations, the visualization output component 416 may include functionality to overlay spatial network plots on anatomical brain images to illustrate electrode positions relative to brain regions. In some implementations, the visualization output component 416 may support interactive visualizations, where users may adjust thresholds for connection frequency or inter-event intervals to explore different clustering behaviors.

FIG. 5 shows a diagram of a system 500 including a device 502 that supports coherence potential assay for brain state and cognitive change detection in accordance with aspects of the present disclosure. The device 502 may be an example of or include the components of a database server or an apparatus 302 as described herein. The device 502 may include components for bi-directional data communications including components for transmitting and receiving communications, including a brain signal analysis component 504, an I/O controller 506, a database controller 508, memory 510, a processor 512, and a database 514. These components may be in electronic communication via one or more buses (e.g., bus 516).

The brain signal analysis component 504 may be an example of a brain signal analysis component 306 or 402 as described herein. For example, the brain signal analysis component 504 may perform any of the methods or processes described above with reference to FIGS. 3 and 4. In some cases, the brain signal analysis component 504 may be implemented in hardware, software executed by a processor, firmware, or any combination thereof.

The I/O controller 506 may manage input signals 518 and output signals 520 for the device 502. The I/O controller 506 may also manage peripherals not integrated into the device 502. In some cases, the I/O controller 506 may represent a physical connection or port to an external peripheral. In some cases, the I/O controller 506 may utilize an operating system such as iOS®, ANDROID®, MS-DOS®, MS-WINDOWS®, OS/2®, UNIX®, LINUX®, or another known operating system. In other cases, the I/O controller 506 may represent or interact with a modem, a keyboard, a mouse, a touchscreen, or a similar device. In some cases, the I/O controller 506 may be implemented as part of a processor. In some cases, a user may interact with the device 502 via the I/O controller 506 or via hardware components controlled by the I/O controller 506.

The database controller 508 may manage data storage and processing in a database 514. In some cases, a user may interact with the database controller 508. In other cases, the database controller 508 may operate automatically without user interaction. The database 514 may be an example of a single database, a distributed database, multiple distributed databases, a data store, a data lake, or an emergency backup database.

Memory 510 may include random-access memory (RAM) and read-only memory (ROM). The memory 510 may store computer-readable, computer-executable software including instructions that, when executed, cause the processor to perform various functions described herein. In some cases, the memory 510 may contain, among other things, a basic input/output system (BIOS) which may control basic hardware or software operation such as the interaction with peripheral components or devices.

The processor 512 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 512 may be configured to operate a memory array using a memory controller. In other cases, a memory controller may be integrated into the processor 512. The processor 512 may be configured to execute computer-readable instructions stored in a memory 510 to perform various functions (e.g., functions or tasks supporting coherence potential assay for brain state and cognitive change detection).

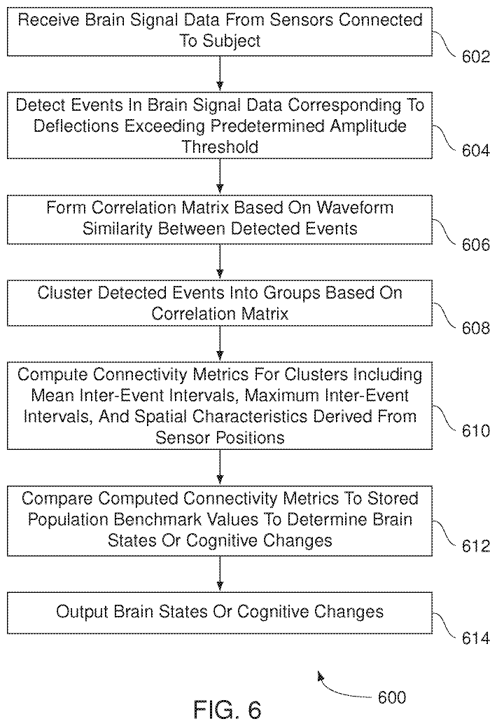

FIG. 6 shows a flowchart illustrating a method 600 that supports coherence potential assay for brain state and cognitive change detection in accordance with various aspects of the present disclosure. The operations of the method 600 may be implemented by one or more components of a networked computing system as described herein. For example, the operations of the method 600 may be performed by a brain signal analysis component as described with reference to FIGS. 3 through 5. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 602, the method 600 may include receiving, by a data processing device, brain signal data from sensors connected to a subject. The operations of 602 may be performed in accordance with examples as disclosed herein. In some examples, aspects of the operations of 602 may be performed by a brain signal receiving component 404 as described with reference to FIG. 4.

At 604, the method 600 may include detecting, by the data processing device, events in the brain signal data, wherein the events correspond to deflections exceeding a predetermined amplitude threshold. The operations of 604 may be performed in accordance with examples as disclosed herein. In some examples, aspects of the operations of 604 may be performed by an event detection component 406 as described with reference to FIG. 4.

At 606, the method 600 may include forming, by the data processing device, a correlation matrix based on waveform similarity between the detected events. The operations of 606 may be performed in accordance with examples as disclosed herein. In some examples, aspects of the operations of 606 may be performed by a correlation matrix formation component 408 as described with reference to FIG. 4.

At 608, the method 600 may include clustering, by the data processing device, the detected events into groups based on the correlation matrix. The operations of 608 may be performed in accordance with examples as disclosed herein. In some examples, aspects of the operations of 608 may be performed by an event clustering component 410 as described with reference to FIG. 4.

At 610, the method 600 may include computing, by the data processing device, connectivity metrics for the clusters, wherein the connectivity metrics include mean inter-event intervals, maximum inter-event intervals, and spatial characteristics derived from sensor positions. The operations of 610 may be performed in accordance with examples as disclosed herein. In some examples, aspects of the operations of 610 may be performed by a connectivity metrics computation component 412 as described with reference to FIG. 4.

At 612, the method 600 may include comparing, by the data processing device, the computed connectivity metrics to stored population benchmark values to determine brain states or cognitive changes. The operations of 612 may be performed in accordance with examples as disclosed herein. In some examples, aspects of the operations of 612 may be performed by a brain state comparison component 414 as described with reference to FIG. 4.

At 614, the method 600 may include outputting, by the data processing device, the brain states or cognitive changes. The operations of 614 may be performed in accordance with examples as disclosed herein. In some examples, aspects of the operations of 614 may be performed by a visualization output component 416 as described with reference to FIG. 4.

Examples of Brain States Assessed with the Assay

The following example is put forth so as to provide those of ordinary skill in the art with a complete disclosure and description of how the compounds, compositions, articles, devices and/or methods claimed herein are made and evaluated, and are intended to be purely exemplary and are not intended to limit the scope of what the inventors regard as their invention. Efforts have been made to ensure accuracy with respect to numbers, but some errors and deviations should be accounted for.

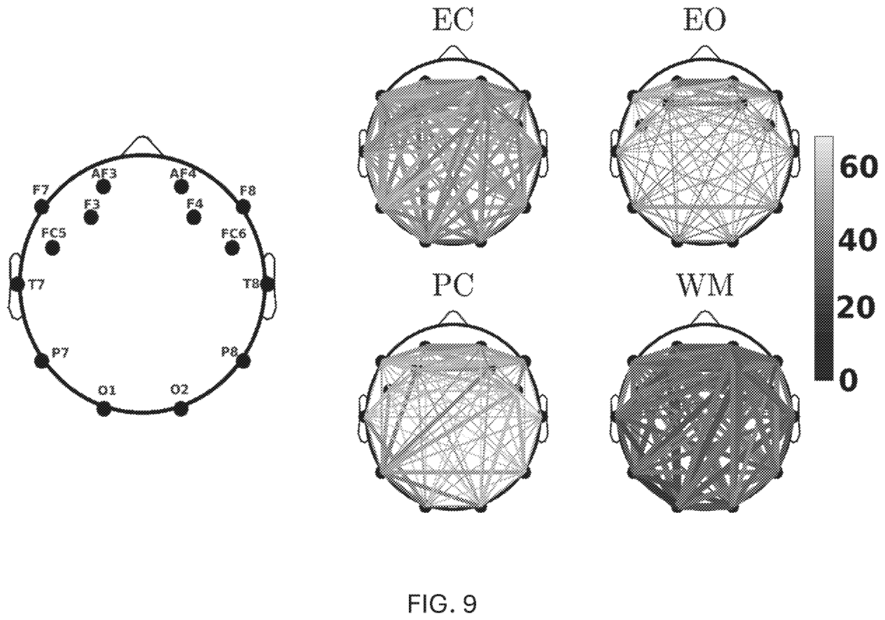

In FIG. 9 a spatial visualization of the coherence potential characteristics (averaged over 25 subjects for each of the tasks-EC, EO, PC and WM). Here the line thickness between electrodes represents the connection frequency while the shade represents the inter-event interval between the electrodes i and j, both averaged across subjects. This visualization shows a clear global increase in connection frequency in the EC task versus EO. It also shows that the WM task is characterized by higher connection frequencies and lower inter-event intervals (indicating faster speed) across all electrode pairs compared to all other tasks. In contrast the PC task is characterized by higher inter-event intervals (indicating slower speeds) particularly in contrast to the WM, and high connection frequencies only at select pairs of electrodes. Altogether this shows that each task is associated with distinct global spatiotemporal characteristics of coherence potentials.

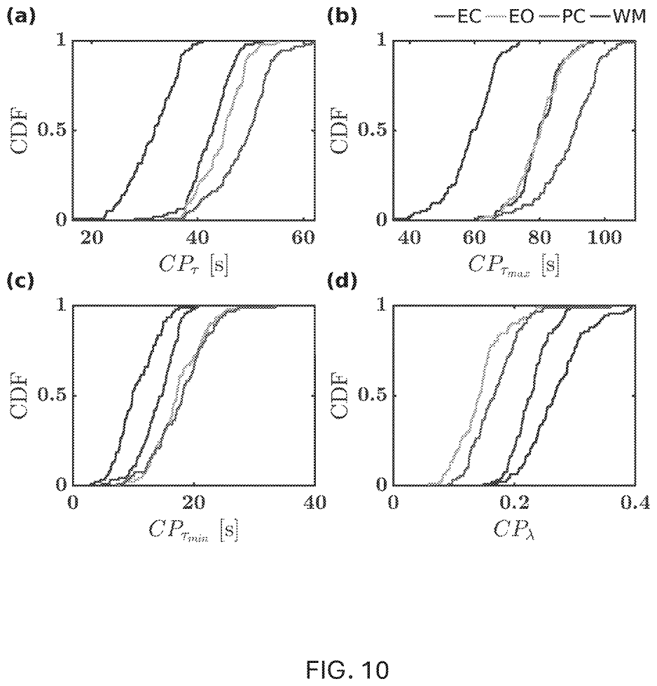

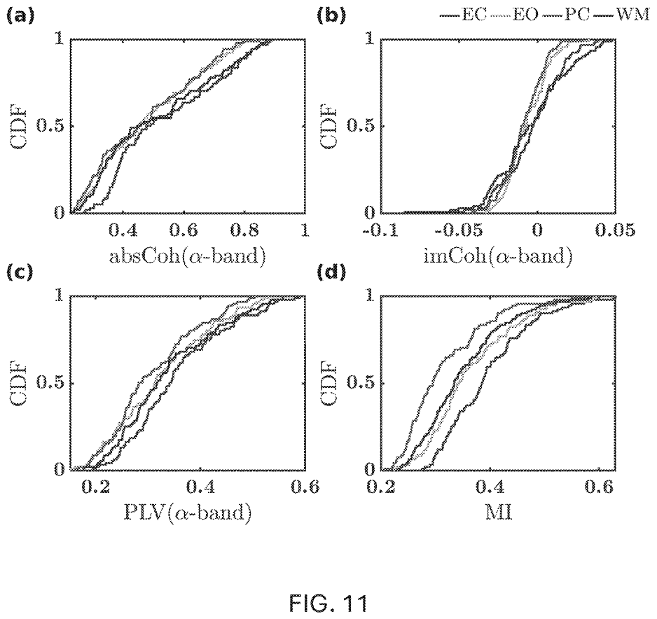

FIG. 10 shows the cumulative distribution function (CDF) of pairwise CP connectivity measures—, CP_{τ}_{ₘᵢₙ} and CP_{λ}, averaged across 25 subjects (group level). It can be seen that the all the CP-based measures distinguish between different tasks. In comparison, other commonly used spectral functional connectivity metrics such as coherence (absCoh), imaginary part of coherence (imCoh) phase locking value (PLV) fail to distinguish between all the tasks as seen in FIG. 11 which depicts CDF of other connectivity measures for group-analysis using TEST1. FIG. 11(a) depicts Absolute Coherence, FIG. 11(b) depicts Imaginary part of coherence, FIG. 11(c) depicts Phase locking value and FIG. 11(d) depicts Mutual information for all the four conditions—EC, EO, PC and WM. The measures for each pair were averaged across all the subjects and the CDF over all possible electrode pairs (14 electrode, 91 pairs) are plotted. For the spectral-based connectivity measures (a-c) only the results from the alpha-band are plotted. However, MI was able to distinguish between all tasks except EO and WM (FIG. 11(d)).

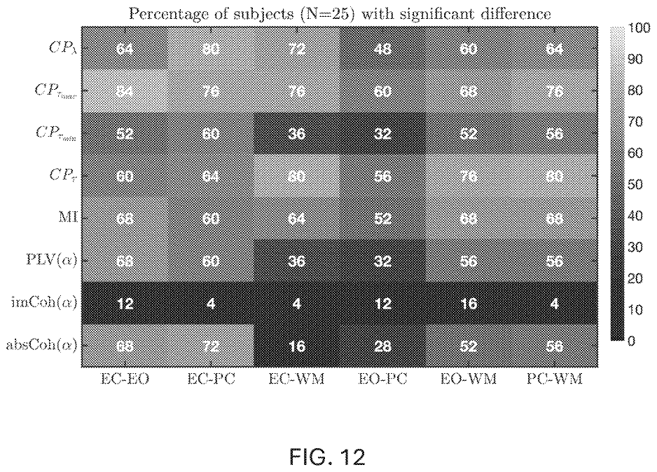

FIG. 12 depicts the comparison of subject-level permutation test results for the proposed CP connectivity measures with spectral-based connectivity metrics (alpha-band) and mutual information TEST 3 (subject-level). The shade corresponds to the percentage of subjects with significant difference after correcting for multiple comparisons using the Bonferroni-Holm method. Results from subject-level analysis depicted in FIG. 12 shows that CP based connectivity measures perform better in the aggregate across all task pairs with the most robust results between WM and both the EC and PC tasks (EC-WM: and for CP_{τ} and CP_{τ,max} respectively and PC-WM: 80% of the subjects for CP_{τ}) where all other connectivity measures performed substantially worse. We also observe that $absCoh$ performed the best among the other connectivity measures, comparable to CP measures CP_{τ,max} and CP_{τ} in distinguishing between EC and PC tasks (72% for absCoh vs 76% for CP_{τ,max} and 80% for CP_{λ}). All the connectivity metrics performed worst in distinguishing between EO and PC with MI performing almost as well as CP measures (52% for MI vs 60% for CP_{τ,max}). Overall imCoh performed the worst among the connectivity measures with no case above 16%. For the spectral-based measures only results from the & band is shown as the & band outperformed other bands for the majority of task pairs.

It should be noted that the methods described herein describe possible implementations, and that the operations and the steps may be rearranged or otherwise modified and that other implementations are possible. Furthermore, aspects from two or more of the methods may be combined.

Aspect 1: A method for coherence potential assay for brain state and cognitive change detection, comprising: receiving, by a data processing device, brain signal data from sensors connected to a subject; detecting, by the data processing device, events in the brain signal data, wherein the events correspond to deflections exceeding a predetermined amplitude threshold; forming, by the data processing device, a correlation matrix based on waveform similarity between the detected events; clustering, by the data processing device, the detected events into groups based on the correlation matrix; computing, by the data processing device, connectivity metrics for the clusters, wherein the connectivity metrics include mean inter-event intervals, maximum inter-event intervals, and spatial characteristics derived from sensor positions; comparing, by the data processing device, the computed connectivity metrics to stored population benchmark values to determine brain states or cognitive changes; and outputting, by the data processing device, the brain states or cognitive changes.

Aspect 2: The method of aspect 1, further comprising detecting events, by the data processing device, in the brain signal data in response to deflections falling below a predetermined amplitude threshold and forming a correlation matrix based on waveform similarity between the detected events.

Aspect 3: The method of any of aspects 1 through 2, further comprising determining, by the data processing device, connectivity metrics for the clusters, wherein the connectivity metrics include connection frequency and inter-event intervals derived from temporal characteristics of the detected events.

Aspect 4: The method of any of aspects 1 through 3, further comprising comparing, by the data processing device, the computed connectivity metrics to stored individual baseline values in addition to the population benchmark values to determine brain states or cognitive changes.

Aspect 5: The method of any of aspects 1 through 4, further comprising receiving, by the data processing device, brain signal data from sensors configured to detect electrical activity, magnetic activity, or derivatives of electrical activity in the brain.

Aspect 6: The method of any of aspects 1 through 5, further comprising outputting, by the data processing device, brain states or cognitive changes as visualizations, wherein the visualizations include spatial network plots with edge thickness representing connection frequency and edge color representing inter-event intervals.

Aspect 7: The method of any of aspects 1 through 6, wherein the brain signal data is pre-processed by the data processing device to filter noise and artifacts prior to detecting events.

Aspect 8: The method of any of aspects 1 through 7, wherein the correlation matrix is formed by the data processing device based on waveform similarity across multiple sensors simultaneously.

Aspect 9: The method of any of aspects 1 through 8, wherein the amplitude threshold for detecting events is dynamically adjusted by the data processing device in response to variations in baseline activity.

Aspect 10: The method of any of aspects 1 through 9, wherein the connectivity metrics computed by the data processing device include spatial trajectories of clusters derived from sensor positions.

Aspect 11: The method of any of aspects 1 through 10, wherein the population benchmark values are updated by the data processing device in response to newly acquired brain signal data from additional subjects.

Aspect 12: The method of any of aspects 1 through 11, wherein the brain states or cognitive changes are output by the data processing device as statistical summaries in addition to visualizations.

Aspect 13: A system for coherence potential assay for brain state and cognitive change detection, comprising a processor; memory coupled with the processor; and instructions stored in the memory and executable by the processor to cause the system to perform a method of any of aspects 1 through 12.

Aspect 14: A system for coherence potential assay for brain state and cognitive change detection, comprising at least one means for performing a method of any of aspects 1 through 12.

Aspect 15: A non-transitory computer-readable medium storing code for coherence potential assay for brain state and cognitive change detection, the code comprising instructions executable by a processor to perform a method of any of aspects 1 through 12.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for determining brain state and cognitive change detection, comprising:
receiving, by a data processing device, brain signal data from sensors connected to a subject;
detecting, by the data processing device, events in the brain signal data, wherein the events correspond to deflections exceeding a predetermined amplitude threshold;
forming, by the data processing device, a correlation matrix based on waveform similarity between the detected events;
clustering, by the data processing device, the detected events into groups based on the correlation matrix;
computing, by the data processing device, connectivity metrics for the clusters, wherein the connectivity metrics include mean inter-event intervals, maximum inter-event intervals, and spatial characteristics derived from sensor positions;
comparing, by the data processing device, one or more of the computed connectivity metrics to stored population benchmark values or values obtained at previous time points to determine brain states or cognitive changes; and
outputting, by the data processing device, the brain states or cognitive changes.

2. The method of claim 1, further comprising:
detecting events, by the data processing device, in the brain signal data in response to deflections falling above or below a predetermined amplitude threshold and forming a correlation matrix based on waveform similarity between the detected events.

3. The method of claim 1, further comprising:
determining, by the data processing device, connectivity metrics for the clusters, wherein the connectivity metrics include connection frequency and inter-event intervals derived from temporal characteristics of the detected events.

4. The method of claim 1, further comprising:
comparing, by the data processing device, the computed connectivity metrics to stored individual baseline values in addition to the population benchmark values to determine brain states or cognitive changes.

5. The method of claim 1, further comprising:
receiving, by the data processing device, brain signal data from sensors configured to detect electrical activity, magnetic activity, or derivatives of electrical activity in the brain.

6. The method of claim 1, further comprising:
outputting, by the data processing device, brain states or cognitive changes as visualizations, wherein the visualizations include spatial network plots with edge thickness representing connection frequency and edge color representing inter-event intervals.

7. The method of claim 1, wherein the brain signal data is pre-processed by the data processing device to filter noise and artifacts prior to detecting events.

8. The method of claim 1, wherein the correlation matrix is formed by the data processing device based on waveform similarity across multiple sensors simultaneously.

9. The method of claim 1, wherein the amplitude threshold for detecting events is dynamically adjusted by the data processing device in response to variations in baseline activity.

10. The method of claim 1, wherein the connectivity metrics computed by the data processing device include spatial trajectories of clusters derived from sensor positions.

11. The method of claim 1, wherein the population benchmark values are updated by the data processing device in response to newly acquired brain signal data from additional subjects.

12. The method of claim 1, wherein the brain states or cognitive changes are output by the data processing device as statistical summaries in addition to visualizations.

13. A system configured for coherence potential assay for brain state and cognitive change detection, comprising:
a processor;
memory coupled with the processor; and
instructions stored in the memory and executable by the processor to cause the system to:
receive brain signal data from sensors connected to a subject;
detect events in the brain signal data, wherein the events correspond to deflections exceeding a predetermined amplitude threshold;
form a correlation matrix based on waveform similarity between the detected events;
cluster the detected events into groups based on the correlation matrix;
compute connectivity metrics for the clusters, wherein the connectivity metrics include mean inter-event intervals, maximum inter-event intervals, and spatial characteristics derived from sensor positions;
compare the computed connectivity metrics to stored population benchmark values to determine brain states or cognitive changes; and
output the brain states or cognitive changes.

14. The system of claim 13, wherein the instructions are further executable by the processor to cause the system to: detect events in the brain signal data in response to deflections falling above or below a predetermined amplitude threshold and form a correlation matrix based on waveform similarity between the detected events.

15. The system of claim 13, wherein the instructions are further executable by the processor to cause the system to: determine connectivity metrics for the clusters, wherein the connectivity metrics include connection frequency and inter-event intervals derived from temporal characteristics of the detected events.

16. The system of claim 13, wherein the instructions are further executable by the processor to cause the system to: compare the computed connectivity metrics to stored individual baseline values in addition to the population benchmark values to determine brain states or cognitive changes.

17. The system of claim 13, wherein the instructions are further executable by the processor to cause the system to: receive brain signal data from sensors configured to detect electrical activity, magnetic activity, or derivatives of electrical activity in the brain.

18. The system of claim 13, wherein the instructions are further executable by the processor to cause the system to: output brain states or cognitive changes as visualizations, wherein the visualizations include spatial network plots with edge thickness representing connection frequency and edge color representing inter-event intervals.

19. The system of claim 13, wherein the brain signal data is pre-processed by the processor to filter noise and artifacts prior to detecting events.

20. A non-transitory computer-readable medium storing code for coherence potential assay for brain state and cognitive change detection, the code comprising instructions executable by a processor to:
receive brain signal data from sensors connected to a subject;
detect events in the brain signal data, wherein the events correspond to deflections exceeding a predetermined amplitude threshold;
form a correlation matrix based on waveform similarity between the detected events;
cluster the detected events into groups based on the correlation matrix;
compute connectivity metrics for the clusters, wherein the connectivity metrics include mean inter-event intervals, maximum inter-event intervals, and spatial characteristics derived from sensor positions;
compare the computed connectivity metrics to stored population benchmark values to determine brain states or cognitive changes; and
output the brain states or cognitive changes.
